(19) United States
(12) Patent Application Publication
(10) Pub. No.: US 2024/0311725 A1
(43) Pub. Date: Sep. 19, 2024

(54) SOLUTION LEARNING AND EXPLAINING IN ASSET HIERARCHY

(71) Applicant: HITACHI VANTARA LLC, Santa Clara, CA (US)

(72) Inventors: Yongqiang ZHANG, Lexington, MA (US); Wei LIN, Plainsboro, NJ (US)

(21) Appl. No.: 18/562,533

(22) PCT Filed: Jun. 30, 2021
(86) PCT No.: PCT/US2021/039863

§ 371 Date: Nov. 20, 2023

(51) Int. Cl. G06Q 10/0631; G06Q 10/067

(52) U.S. Cl. CPC G06Q 10/06316; G06Q 10/067

(57) ABSTRACT

Systems and methods described herein are directed to generating an asset hierarchy from a plurality of assets, the asset hierarchy indicative of relationships among the plurality of assets from a lowest level to a highest level; executing a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and storing, in storage, the asset hierarchy, the one or more model solutions for the each one of the plurality of assets, and the knowledge for solution explanation for the one or more model solutions.

### BACKGROUND

### Field

The present disclosure is generally directed to into the Internet of Things (IoT) and Operational Technology (OT) domains, and more specifically, to facilitating solution learning and explanation in asset hierarchies.

### Related Art

An asset hierarchy is a logical and/or physical way to organize all the machines, equipment and individual components owned by a company in one or more locations. The top-down structure allows maintenance professionals to understand the relationship among assets using a “parent-child” relationship.

FIG. 1 illustrates an example of an asset hierarchy. The example asset hierarchy of FIG. 1 is: Industry→Business Category→Plant/Unit→Section/System→Equipment Unit→Component→Parts. Here “Industry” is the top level asset, and “Business Category” is the sub-asset of “Industry”, and so on. As demonstrated in FIG. 1, the asset hierarchy can organize the assets in a logical way and/or the physical way, and can include other sub-components of the assets (e.g., sensors installed on the parts) in accordance with the desired implementation.

Once the assets of interest are organized into an asset hierarchy, it can facilitate understanding of the physical and logical relationships of different degrees among the assets, asset management and smarter asset life cycle decisions, more efficient asset maintenance and repair scheduling (e.g., in terms of time, cost and cost of ownerships), as well as faster identification of root causes.

Given a set of assets, their relationships need to be identified and then be used to build the asset hierarchy. Depending on the type of relationships and the genericity of the asset hierarchy, different asset hierarchy can be built.

There are two types of relationships among assets. A first type of relationship can be the physical relationship, which indicates how the assets are physically attached or connected together. The physical relationship is usually “compositional”, also called parent-child relationship where one asset is a child of another asset. In FIG. 1, the bottom three levels (“Equipment Unit”→“Component”→“Parts”) represent the physical relationships among assets.

A second type of relationship can be a logical or functional relationship: this means which group of assets serves as a logical or functional unit, and such logical/functional unit can be defined as a logical/functional asset. Note the logical or functional unit itself can also be at different levels: a smaller set of functional units is usually located at the lower level while a larger set of functional units is located at the higher level. In FIG. 1, the top five levels (“Industry”→“Business Category”→“Plant/Unit”→“Section/System”→“Equipment Unit”) represent the logical relationships among the assets.

Given a set of assets, an asset hierarchy can be built to serve most of the tasks. For instance, the tasks can involve failure detection, failure prediction, remaining useful life, operator skill evaluation, and so on. Such an asset hierarchy is generic, and it can be either based on physical relationships among the asset or logical/functional relationships among the assets.

Sometimes, there is a business need to solve only one task and only the relevant assets and asset relationships need to be retained in the asset hierarchy. For instance, in an operator skill evaluation task, only the assets that can be operated need to be considered in the asset hierarchy. Such asset hierarchy is task-oriented and it can be either based on physical relationships among the asset and/or logical/functional relationships among the assets for their cost functions accordingly.

Given an asset and a problem on the asset, physics-based modeling and/or machine learning techniques can be applied to solve the problem. For instance, there are “thickener tailing” asset in a coal mining plant, and anomaly detection and prediction techniques can be applied to solve the failure detection and prediction problem. Conventionally, the solution is built per asset per problem, and the relationships among the assets and the problems are not considered and utilized. Besides, the corresponding optimizations are locally constrained (e.g. optimize efficiency in terms of time, cost or ownerships) which cannot be leveraged across solutions.

Another related task for the solution is to explain the model and the results and generate the prescriptive actions in order to prevent or remediate the problems in the asset. This includes but is not limited to: root cause analysis, remediation recommendation, alert suppression, and so on. Conventionally, there is limited work on explaining the solution, which is done per asset per problem.

### SUMMARY

Several limitations and restrictions of conventional systems and methods are discussed below. The example implementations introduce techniques to solve these problems.

Firstly, learning a solution for a problem in the related art is usually done at the individual asset level (i.e., component-based learning). The problem(s) in an asset of the interest are recognized and then physics-based solutions and/or machine learning solution(s) are built for the asset separately. Since the assets in a system work as a whole and the working condition and/or performance of one asset may affect other assets (e.g., such as immediate upstream assets and downstream assets), the solution without the inclusion of relationships among assets will not work well. To address this problem, example implementations described herein identify the relationships among assets, and utilize such relationships as part of the learning process in order to build a more accurate and effective solution.

Secondly, explaining a solution for a problem and the results from the solution in the related art is usually done at the individual asset level (i.e., component-based explaining). This is related to the first problem in which the solution is built for each asset separately. Since the assets in a system work as a whole and the working condition and/or performance of one asset may affect other assets (especially immediate upstream assets and downstream assets), explaining the solution and the result by focusing on only the asset that exposes the problem may miss the root cause of the problem and may not work well. To address this problem, example implementations described herein identify the relationships among assets and utilize such relationships as part of the explaining process in order to explain the solution and the result correctly.

Thirdly, in the related art, representation and storage of the information in an asset hierarchy, the solutions, and the expert data store for solution explaining is done through a relational database, which is ineffective for representing the relationship information and facilitating efficient querying of the results. To address this problem, example implementations described herein identify the relationships among assets, solutions and expert data store and utilize a representation that can better capture the relationships and store the representation for easier access and more efficient querying.

To address the above problems of the related art, several techniques are introduced.

One technique in the example implementations involves solution learning in an asset hierarchy, involving several learning schemes, are utilized for both supervised learning and unsupervised learning to learn and build the solutions for assets in asset hierarchy, by utilizing the hierarchical relationships among assets.

Another technique in the example implementations involves solution explaining in an asset hierarchy, which involves a root cause attribution model that help explain the result at both the solution and individual result level.

Another technique in the example implementations involves solution representation and storage in an asset hierarchy, which involves an approach to represent and store the information in asset hierarchy, the solutions and an expert data store for solution explaining.

Aspects of the present disclosure can involve a method, which can involve generating an asset hierarchy from a plurality of assets, the asset hierarchy indicative of relationships among the plurality of assets from a lowest level to a highest level: executing a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and storing, in storage, the one or more model solutions for the each one of the plurality of assets, knowledge from the generated solution explanation for the one or more model solutions, and the asset hierarchy as a solution representation.

Aspects of the present disclosure can involve a computer program, which can involve instructions involving generating an asset hierarchy from a plurality of assets, the asset hierarchy indicative of relationships among the plurality of assets from a lowest level to a highest level: executing a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and storing, in storage, the one or more model solutions for the each one of the plurality of assets, knowledge from the generated solution explanation for the one or more model solutions, and the asset hierarchy as a solution representation. The computer program and instructions may be stored in a non-transitory computer readable medium and executed by one or more processors.

Aspects of the present disclosure can involve a system, which can involve means for generating an asset hierarchy from a plurality of assets, the asset hierarchy indicative of relationships among the plurality of assets from a lowest level to a highest level: means for executing a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and means for storing, in storage, the one or more model solutions for the each one of the plurality of assets, knowledge from the generated solution explanation for the one or more model solutions, and the asset hierarchy as a solution representation.

Aspects of the present disclosure can involve an apparatus, which can involve a processor, configured to generate an asset hierarchy from a plurality of assets, the asset hierarchy indicative of relationships among the plurality of assets from a lowest level to a highest level: execute a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and store, in storage, the one or more model solutions for the each one of the plurality of assets, knowledge from the generated solution explanation for the one or more model solutions, and the asset hierarchy as a solution representation.

### BRIEF DESCRIPTION OF DRAWINGS

FIG. 1 illustrates an example of an asset hierarchy.

FIG. 2 illustrates a solution architecture for solution learning, solution explaining, and solution representation and storage for assets in an asset hierarchy, in accordance with an example implementation.

FIG. 3 illustrates the system architecture in which the solutions are built, executed and explained, in accordance with an example implementation.

FIG. 4 illustrates an example on how the bottom-up learning scheme works in an asset hierarchy, in accordance with an example implementation.

FIG. 5 illustrates a flowchart for the learning algorithm in bottom-up learning scheme, in accordance with an example implementation.

FIG. 6 illustrates an example on how the reactive learning scheme works in an asset hierarchy, in accordance with an example implementation.

FIG. 7 illustrates a flowchart for the learning algorithm in reactive learning scheme, in accordance with an example implementation.

FIG. 8 illustrates an example on how the deep learning scheme works in an asset hierarchy, in accordance with an example implementation.

FIG. 9 illustrates an example on how the solution explaining scheme works in an asset hierarchy, in accordance with an example implementation.

FIG. 10 illustrates an example data type for knowledge graph, in accordance with an example implementation.

FIG. 11 illustrate an example process to build a knowledge graph, in accordance with an example implementation.

FIG. 12 illustrates an example of the information that are stored in each node of knowledge graph, in accordance with an example implementation.

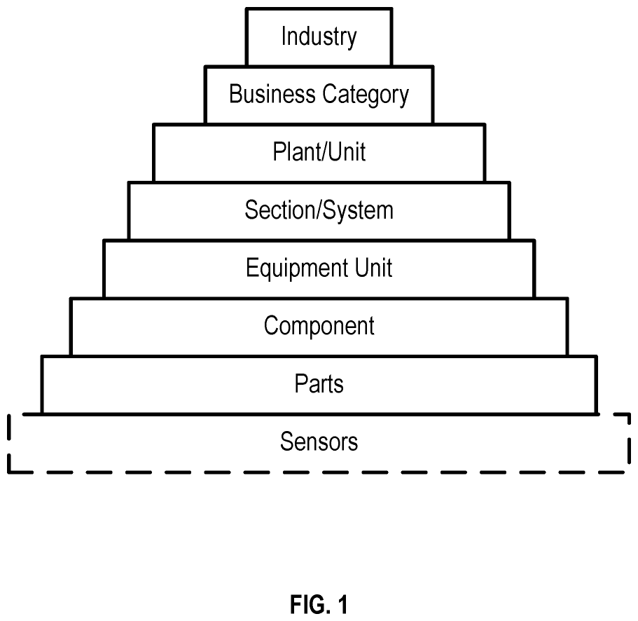

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

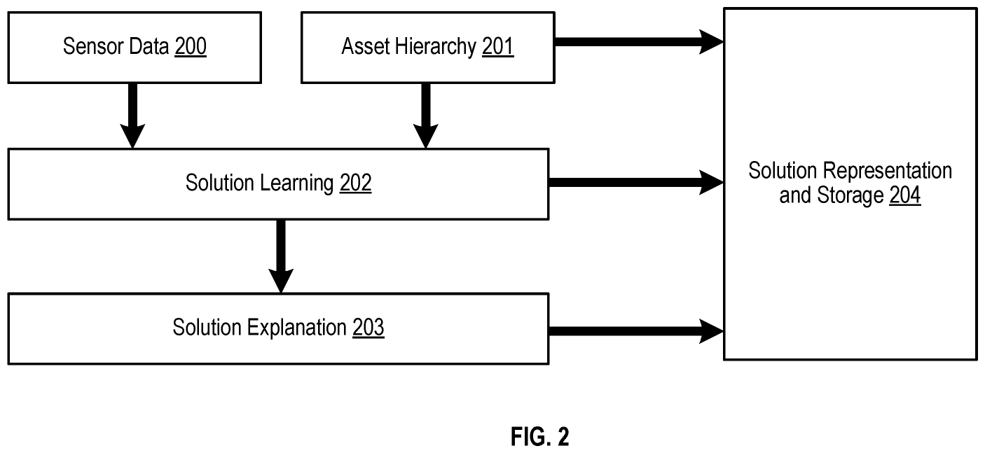

FIG. 2 illustrates a solution architecture for solution learning, solution explaining, and solution representation and storage for assets in an asset hierarchy, in accordance with an example implementation. The solution architecture can involve the following elements. Sensor data 200 is collected and preprocessed for solution building. Asset hierarchy 201 includes the relationship among the assets, and is captured, represented and stored. The asset hierarchy can capture the physical relationships and/or logical relationships among the assets. Solution learning 202 introduce several learning schemes to build model solutions (or “solutions” for short) based on sensor data and asset hierarchy. The model solutions are learned models that are used as the solution for Solution explanation 203 involves model(s) from which the solution and solution output can be explained by utilizing the asset hierarchy. Explaining the solution and the solution output may involve identification of leading factors to a prediction result from the learned models in solution learning 202. For example, identification the root causes or leading factors to a predicted failure can be part of the functions in solution explanation 203. Solution representation and storage 204 manages representations of the asset hierarchy, the solutions from solution learning 202, and knowledge from the solution explanation 203 such as the mapping between the root causes to recommended actions, and is stored in a way for efficient query. Accordingly, the storage of solution representation and storage 204 stores the asset hierarchy 201, the one or more model solutions for the each one of the plurality of assets from solution learning 202, and the knowledge for a solution explanation for the one or more model solutions from solution explanation 203.

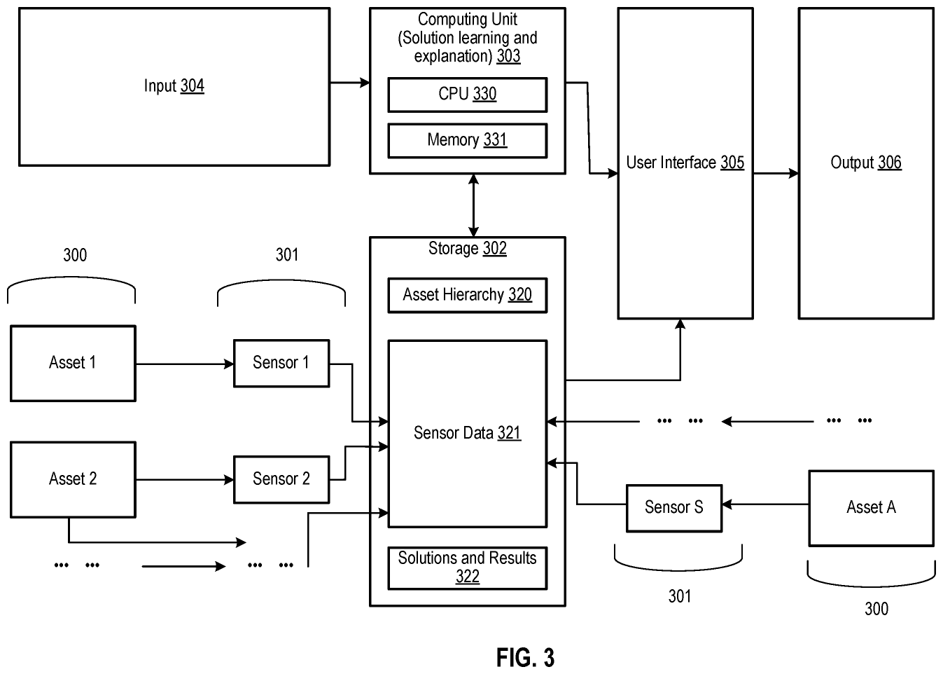

FIG. 3 illustrates the system architecture in which the solutions are built, executed and explained, in accordance with an example implementation. The system can include the following elements. Assets 300 can involve the physical assets in the asset hierarchy. Sensors 301 can involve the sensors that are installed on the assets. In an example implementation, each sensor is attached to a corresponding asset.

Storage 302 can involve storage devices or storage systems that stores the asset hierarchy 320, sensor data 321, and the solutions and solution results 322.

Computing unit 303 can be a computing device that includes central processing unit (CPU) 330 and memory 331 where the solutions are built, executed and explained. The computing unit 303 retrieves the data from storage device: builds, executes and explains the solution; and then store the solutions and results into the storage device. Depending on the data volume, number and complexity of the solutions, the computing unit may include different number of CPUs 330 and/or graphics processing units (GPUs), different amount of memories, different number and types of computing machines, and so on. The parallel computing devices and edge computing devices may be incorporated here as well. Any hardware configuration that facilitates the functionality of computing unit 303 can be utilized in accordance with the desired implementation. CPUs 330 can involve one or more processors such as hardware processors or combinations of hardware and software processors.

Input 304 can include the devices that the data scientists, engineers, operators, and so on, use to interact with the computing unit 303 such as a mouse, keyboard, and so on in accordance with the desired implementation.

User interface 305 is the software that can show the data and results. Output 306 includes the devices that can show the user interface, such as a monitor, a printer, and so on.

Each element in the solution architecture is discussed in detail below.

Asset hierarchy 320 captures the relationships among assets in a hierarchical tree structure. As described herein, asset hierarchy 320 can be built based upon physical relationships among assets, and/or logical or functional relationships among assets. Asset hierarchy 320 can be generic for multiple tasks or specific for one task only depending on the desired implementation.

The asset hierarchy 320 can be visualized with a hierarchical tree structure. In order to use the information in the asset hierarchy 320 to build a solution, example implementations represent and store the asset hierarchy 320 in a way that can be easily and efficiently queried. In example implementations described herein, the knowledge graph is used to represent and store the asset hierarchy 320, which is discussed in further detail herein.

Sensor data 321 can involve data from IoT (Internet of Things) sensors that are installed on the assets of interest and used to collect data to monitor the health status and the performance of the asset. Different types of sensors are designed to collect different types of data among various industries, assets, and tasks. In this context, there is no need to differentiate between the sensors and most sensors can be assumed to be relevant to the solutions introduced herein.

As will be described herein, in a first aspect, CPU 330 can be configured to generate an asset hierarchy from a plurality of assets, the asset hierarchy indicative of relationships among the plurality of assets from a lowest level to a highest level: execute a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and storing, in storage, the asset hierarchy, the one or more model solutions for the each one of the plurality of assets, and the knowledge for solution explanation for the one or more model solutions as illustrated through the flow of FIG. 2.

In a second aspect, CPU 330 can involve the first aspect and be further configured to generate a solution explanation for each of the outputs of the model solutions for the each of the plurality of assets from the highest level to the lowest level as illustrated for the flow of FIG. 2.

In a third aspect, CPU 330 can involve any of the above aspects and be further configured to store, in storage, the asset hierarchy, the one or more model solutions for the each one of the plurality of assets, and the knowledge for solution explanation for the one or more model solutions by generating a first knowledge graph, the first knowledge graph involving a plurality of first nodes and a plurality of first edges, each of the plurality of first nodes representative of an asset from the plurality of assets and associated with the one or more model solutions for the asset from the plurality of assets, each of the plurality of first edges representative of the relationships among the plurality of assets: generating a second knowledge graph, the second knowledge graph involving a plurality of second nodes and a plurality of second edges, each of the plurality of second nodes involving the knowledge for the solution explanation of the model solution for the each one of the plurality of assets, and each of the plurality of second edges representing a relationship between the knowledge for the solution explanation for the one or more model solutions; and storing the first knowledge graph and the second knowledge graph as the solution representation as illustrated in FIGS. 2 and 10-12.

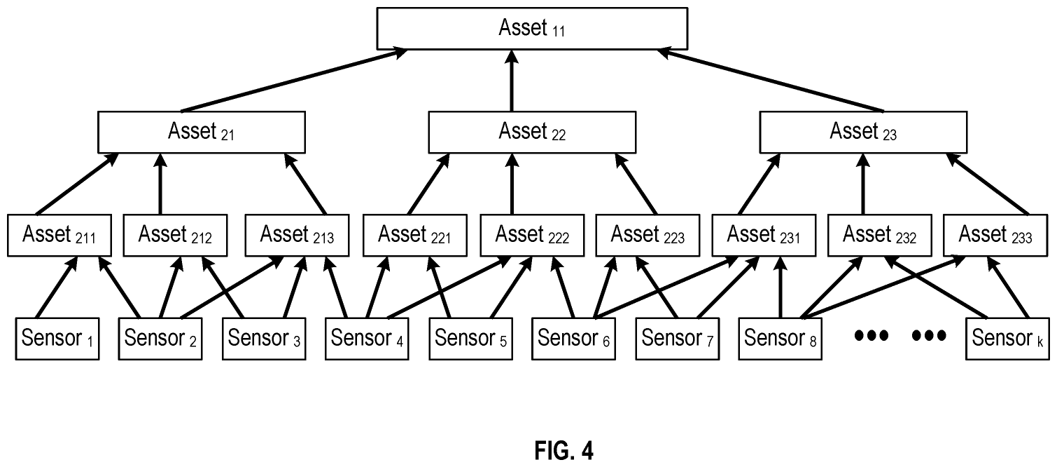

In a fourth aspect, CPU 330 can involve any of the above aspects and be further configured to generate the solution explanation for the outputs of the one or more model solutions for the each of the plurality of assets from the highest level to the lowest level, by determining a root cause for each output of the one or more model solutions based on one or more of execution of a trace-down process from a higher level to a lower level of the each of the plurality of assets, execution of an explaining scheme according to cross-level ones of the plurality of relationships, and execution of a learning scheme by using as the target the root cause derived from outputs of the one or more model solutions of the each of the plurality of assets; and incorporating the root cause as the knowledge for the solution explanation for the one or more model solutions as illustrated in FIGS. 4-5 and 10-12.

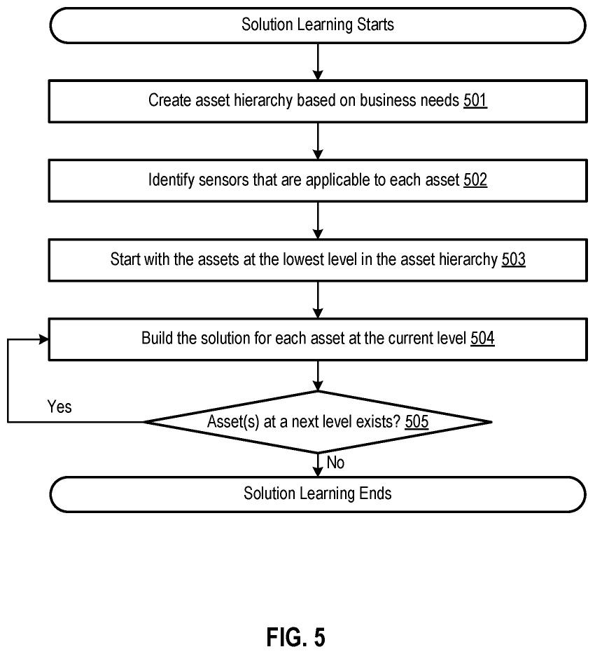

In a fifth aspect, CPU 330 can involve any of the above aspects, wherein the solution learning process involves learning the one or more model solutions for the each of the plurality of assets from the lowest level first: wherein the outputs of the one or more model solutions of lower levels are utilized as inputs to learn the one or more model solutions in higher levels of the asset hierarchy in an iterative manner from the lowest level to the highest level as illustrated in FIGS. 4 and 5.

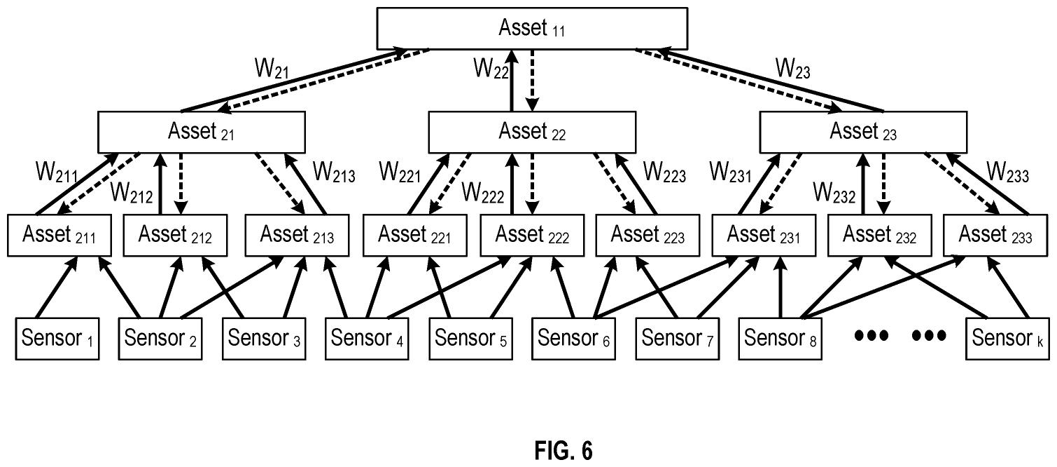

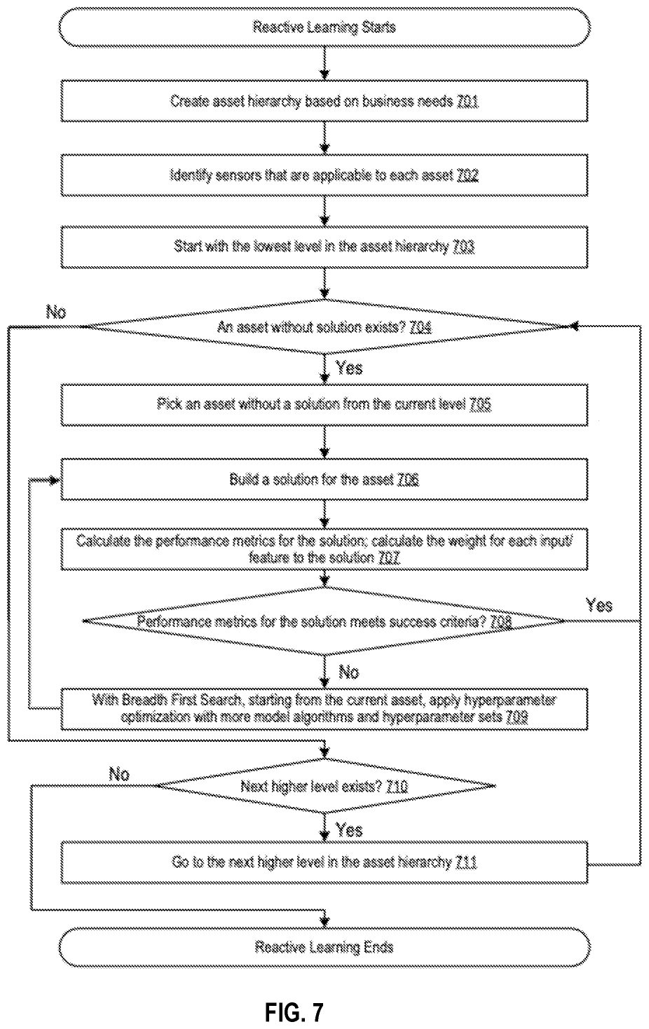

In a sixth aspect, CPU 330 can involve any of the above aspects, wherein the solution learning process involves calculating model performance metrics for the one or more model solutions and a weight for each of the inputs to the each of the plurality of assets: for the model performance metrics meeting a success criteria, proceeding with the solution learning process to a next one of the each of the plurality of assets: for the model performance metric not meeting the success criteria, traversing, from the each of the plurality of assets, ones of the plurality of assets that are at the lower level in the asset hierarchy in a descending order of weights at each level: for each of the ones of the traversed plurality of assets, executing a broader set of model algorithms and parameter sets to generate a plurality of model solutions, and applying hyperparameter optimization to the plurality of model solutions to select the model solution as illustrated in FIGS. 6 and 7.

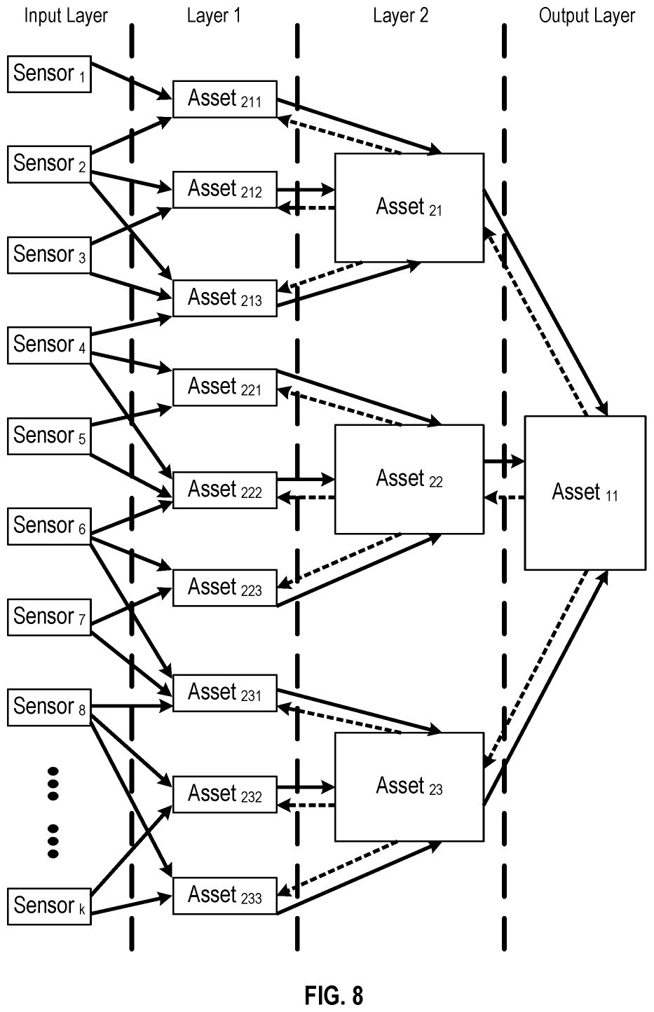

In a seventh aspect, CPU 330 can involve any of the above aspects wherein the solution learning process involves generating a deep neural network to represent the asset hierarchy, the deep neural network involving an input layer representative of sensors associated with the plurality of assets: an output layer representative of ones of the plurality of assets at the highest level in the asset hierarchy; and one or more hidden layers representative of assets at other levels in the asset hierarchy: wherein connections between the neural network layers represent one or more of a physical or a logical relationship in the asset hierarchy as illustrated in FIG. 8.

In an eighth aspect, CPU 330 can involve any of the above aspects, wherein the solution learning process further involves using the model performance metrics from the one or more model solutions at the lower levels as the input to learn the one or more model solutions at the higher levels: wherein each of the plurality of assets is associated with the one or more model solutions for one or more tasks: wherein each of the plurality of assets is associated with one or more versions of the one or more model solutions for each of the one or more tasks; wherein the one or more model solutions are based on one or more of machine learning model algorithms or physics-based models: wherein the one or more model solutions are configured to identify and utilize fault tolerance relationships among one or more of sensors or assets in the asset hierarchy, wherein some of the one or more of sensors or assets are configured to have a similar function or role in the system: wherein the one or more model solutions are configured to capture and utilize cross-level relationships among assets, where the input for the one or more model solutions for an asset is from one or more of the assets or the sensors at differing lower levels; and wherein the asset hierarchy is refined by removing connections based on the feature importance in the one or more model solutions as illustrated in FIGS. 4-12.

In a ninth aspect, CPU 330 can involve any of the above aspects, wherein the solution learning process further involves using a traversal algorithm (e.g., such as Depth First Search (DFS) algorithm, Breadth first search algorithm, etc.) to traverse ones of the plurality of assets below a current asset by following the descending order of the weights; and using the weights on the connections to limit ones of the plurality of assets to be traversed as illustrated in FIGS. 5-9.

In a tenth aspect, CPU 330 can involve any of the above aspects, wherein the solution learning process further involves building the deep neural network to generate multiple outputs with each output for an asset from the plurality of assets in the asset hierarchy: wherein each of the plurality of assets is associated with the one or more model solutions for one or more tasks; and the one or more model solutions are configured to capture and utilize cross-level relationships among the plurality of assets, wherein the links connect pairs of assets in non-adjacent layers in the deep neural network as illustrated in FIGS. 4-9.

In an eleventh aspect, CPU 330 can involve any of the above aspects and be further configured to generate the asset hierarchy through a deep learning scheme, the generating the asset hierarchy involving identifying ones of the plurality of assets at each level: generating a fully connected neural network comprising a plurality of nodes, wherein ones of the plurality of nodes at the each level are connected to other ones of the plurality of levels at a higher level over a plurality of connections: training the fully connected neural network and obtaining weights for each of the plurality of connections; and pruning the plurality of connections in the fully connected neural network by removing ones of the plurality of connections having weights that are lower than a predefined threshold as illustrated in FIGS. 4 and 8.

In a twelfth aspect, the asset hierarchy is representative of one or more of a physical hierarchy or a logical hierarchy of the plurality of assets.

In a thirteenth aspect, there is a method for executing any of the above aspects.

In a fourteenth aspect, there is a computer program storing instructions for executing any of the above aspects. The computer program and instructions can be stored in a non-transitory computer readable medium and executed by one or more processors.

In a fifteenth aspect, there is a system having means for executing any of the above aspects.

There are situations in which the data collected by one sensor S₁ is closely related to the data collected by another sensor S₂. In this case, S₁ can be a substitution of S₂ and vice versa. For example, the wind turbine axis torque can also be approximately represented by the amount of vibration generated by the generator and vice versa. Such substitutional or redundant relationships can be obtained based on domain knowledge and/or data analysis (such as correlation analysis). Redundant sensors allow fault tolerance: when one sensor is not functional, the other sensor can be used as a substitute to build the solution. Further, faulty sensor(s) can be recognized when such redundant relationships are no longer maintained.

In solution learning 202, there are various learning schemes for assets in the asset hierarchy. In a first example, there is a bottom-up learning scheme. In this learning scheme, data and results from solutions at lower levels in asset hierarchy can be used as inputs to the solutions at the higher levels. FIG. 4 illustrates an example on how the bottom-up learning scheme works in an asset hierarchy, in accordance with an example implementation. In this example, “Asset₁₁” is the asset at the highest level (i.e., root asset): “Asset₂₁”, “Asset₂₂” and “Asset₂₃” are assets at the next highest levels, and so on. The direct relationships among the assets are represented with the arrows. For example, “Asset₁₁” has direct relationship with “Asset₂₁”, “Asset₂₂” and “Asset₂₃”. The relationship can be physical and/or logical.

FIG. 5 illustrates the learning algorithm in bottom-up learning scheme, in accordance with an example implementation. At 501, the algorithm creates the asset hierarchy based on the business needs. The asset hierarchy can be physical and/or logical/functional: it can be generic or task-oriented in accordance with the desired implementation. At 502, the algorithm identifies sensors that are applicable to each asset at the lowest level (i.e., leaf asset). Each asset can be associated with multiple sensors: each sensor can be associated with multiple assets. At 503, the algorithm builds solution(s) for each leaf asset first. At 504, outputs of solutions at lower level are used by the algorithm as inputs to build the solution at next higher level by following the asset hierarchy. The outputs of solutions at lower levels can be considered as derived features to build the solution at next higher level. At 505, the process continues until the asset at the highest level is reached.

Further, there are several variations for the above bottom-up learning scheme that can be utilized in accordance with the desired implementation. In one example, model performance metrics can be used as input, such that the model performance metrics from the one or more model solutions at the lower level can be used as the input to learn the one or more model solutions at the higher levels. When building a solution for an asset, the model performance metrics from the solutions at lower level(s) can be used as part of the input to build the solution at next higher level. By intuition, this indicates the “confidence” of the output from the solutions at lower level(s). The metrics include, but is not limited to, model-based metrics (e.g., accuracy, precision, recall, etc.) and/or business-based metrics (e.g., time between failure, production yields, and so on). We can use one or more such model performance metrics from the solutions at lower level(s) as the input(s) to build the solutions at next higher level. Such metrics are calculated based on historical data, where the ground truth target data are available and can be used to compare with the derived/predicted target values and calculate the model-based metrics and/or business-based metrics.

In another example variation, there can be multiple outputs. The solution can be built for each asset in the asset hierarchy and the solution for each asset can produce output to solve the business problem(s) for the asset(s) of interest.

In another example variation, there can be multi-tasking across problems. In a system, multiple business problems may exist. Depending on the desired implementation, each of the plurality of assets is associated with the one or more model solutions for the one or more tasks. With multiple bottom-up learning schemes, multiple tasks can be done together to solve these problems. For this purpose, each asset can be associated with several solutions for different tasks. One example is that each asset is associated with multiple solutions (e.g., anomaly detection, clustering, failure detection, remaining useful life, failure prediction, etc.) The output from each solution for assets at lower level can be used as the input to build the solution for assets at higher level. The solution of one task for the asset at lower level can help with the solution for all tasks for the asset at a higher level.

In another example variation, there are heterogeneous models. Each task may have several versions of the solutions for each asset. For instance, multiple model algorithms can be applied to each task for an asset. Thus, several solutions can be obtained for each task for the asset. The output from each solution at lower level can be used as the input to build the solutions at a higher level. For a task, the solution for the asset at lower level can help with solutions for the asset at higher level.

In another example variation, there are semi-empirical solutions. The solution may be based on machine learning model algorithms and/or physics-based models. Machine learning models are data-driven approaches which apply machine learning model algorithms to the available data and build solutions. Physics-based models, on the other hand, try to capture the underlying relationship among limited variables with a target variable based on the domain knowledge, and form a formula or equation among them. The physics-based model is typically verified and fine-tuned by simulation process. To take advantage of both solutions, they can be combined into a learning scheme. For each asset, machine learning solutions and physics-based solutions can be built. The output from the machine learning solution and/or the physics-based solution for assets at a lower level can be used as the input to build the machine learning solution and/or physics-based solution for assets at a higher level.

In another example variation, there is also fault tolerance. Some sensors and/or assets in the asset hierarchy have the same or a similar function or role in the system. This includes the substitutional sensors as described herein. This facilitates fault tolerance, meaning that if one asset fails to work, if the other asset having the same function or role works, then the whole system still works. The redundancy relationship can be reflected and captured in the asset hierarchy. Accordingly, the solutions will reflect such relationship as well. For example, if “Asset₂₁” and “Asset₂₂” has the same function in the system and a failure for “Asset₂₁” is predicted, but no failure for “Asset₂₂” is predicted, then “Asset₁₁” will not get impacted by the failure of “Asset₂₁”. Accordingly, the one or more model solutions can be configured to identify and utilize fault tolerance relationships among one or more of sensors or assets in the asset hierarchy, where some of the one or more of sensors or assets are configured to have a similar function or role in the system.

In another example variation, there is a cross-level relationship. When a solution is built for an asset, the input for the solution can come from assets or sensors at differing lower levels. Such asset hierarchy is essentially represented by a graph. There are two cases as described below.

In a first case, data from sensors can be used as the input to build the solution for each asset in the asset hierarchy. For example, when building a solution for “Asset₂₁”, the sensors that are related to this asset may be input to this asset directly. For instance, “Sensor₁”, “Sensor₂”, “Sensors” and “Sensor₄”, along with the existing input from the assets at next lower level can be used as the input to build the solution for “Asset₂₁”.

In a second case, the output from the solutions for an asset at lower levels can be used as the input to build the solution for another asset at higher levels in the asset hierarchy. For example, when building a solution for “Asset₁₁”, the output from the solutions for “Asset₂₃₁” can be used as the input to build solution for this asset directly.

In another example variation, there is asset hierarchy refinement. When building a solution for an asset, feature selection techniques and/or explainable artificial intelligence (AI) techniques in machine learning can be used to determine which features are important or critical to build the solution. Such information can be used to refine the asset hierarchy structure: the connections for the less important features (corresponding to the sensors or the assets at lower levels) will be removed. Note that such removal of connections in the asset hierarchy may be specific to the problem or task, and may not apply to another task.

In a second example learning scheme, there is the reactive learning scheme. In this learning scheme, data and results from solutions at lower levels in the asset hierarchy can be used as inputs to build the solutions at the higher levels: the results from the solutions at higher levels can be used as feedback to improve the solutions at lower levels.

FIG. 6 illustrates an example on how the reactive learning scheme works in an asset hierarchy, in accordance with an example implementation. In this example, “Asset₁₁” is the asset at the highest level (i.e., root asset): “Asset₂₁”, “Asset₂₂” and “Asset₂₃” are assets at the next highest levels, and so on. The direct relationships among the assets are represented with the solid arrows. For example, “Asset₁₁” has direct relationship with “Asset₂₁”, “Asset₂₂” and “Asset₂₃”.

Each solid arrow is associated with a weight which indicates the contribution of the solutions for assets at lower levels to the solutions for assets at higher levels. The weight is measured per each solution for the asset at a higher level. For example, the solution for “Asset₁₁” include three weights: “w₂₁” indicates the contribution of the solution for “Asset₂₁” to the solution for “Asset₁₁”: “w₂₂” indicates the contribution of the solution of “Asset₂₂” to the solution for “Asset₁₁”: “w₂₃” indicates the contribution of the solution for “Asset₂₃” to the solution for “Asset₁₁”. The contribution can be computed based on the techniques to determine the feature importance of the model. For example, for random forest model, we can compute how much each feature contributes to decreasing the weighted impurity or variances based on their positions in the trees. Each feature of the model is associated with a feature importance value to indicate its importance in the model or solution. There are various techniques to determine the feature importance for different types of model algorithms.

The feedback from the solutions at the higher levels to the solutions at lower levels are represented by dashed arrows. For example, the feedback from solution for “Asset₁₁” can be used to improve the solutions for “Asset₂₁”, “Asset₂₂” and “Asset₂₃”.

FIG. 7 illustrates a flowchart for the learning algorithm in reactive learning scheme, in accordance with an example implementation.

At 701, the algorithm creates the asset hierarchy based on the business needs. The asset hierarchy can be physical and/or logical/functional; it can be generic or task-oriented. At 702, the algorithm identifies sensors that are applicable to each asset at the lowest level (i.e., leaf asset). Each asset can be associated with multiple sensors; each sensor can be associated with multiple assets. At 703, the algorithm starts from the lowest level in the asset hierarchy and proceeds to 704 to determine if an asset without a solution exists. If so (yes), the algorithm picks an asset without a solution at 705 and builds a solution for it at 706. The outputs of solutions at lower level serve as inputs to build the solution at next higher level by following asset hierarchy. By intuition, the model output can be considered as derived features. The solutions are built all the way to the assets at the highest level (i.e., the root leaf).

At 707, the algorithm calculates the model performance metrics and the weight for each input to the current asset with an explainable AI technique. At 708, if the metric value meets the predefined success criteria (yes), then the algorithm proceeds to 704 to continue with the next asset without a solution in the current level. Otherwise (no), the flow proceeds to 709 and starts with the current asset A and traverses assets lower than the current asset by following the asset hierarchy with a traversal algorithm such as a Breadth First Search (BFS) algorithm.

In the BFS algorithm, at each level, the algorithm follows the descending order of the weights to the next higher level asset:

(a) For each asset that is traversed, try a broader set of model algorithms and parameter sets and apply hyperparameter optimization to select the best solution.

(b) Calculate the model performance metrics for the best solution.
If the metric value meets the predefined success criteria,
   If the current asset is asset A, continue with the next asset without a solution in the current level.
   Otherwise, re-build the solution for the parent asset of the current asset. This continues until asset A is reached.
Otherwise, for each child asset of the current asset, go back to (a).

At 710 a determination is made if the next higher level exists. If so (yes) then the flow proceeds to 711 to proceed to the next level and reiterate from 704 again. Thus, the process continues until the asset at the highest level is reached and the solution for each asset is built with a model performance metrics meeting the predefined success criteria.

Further, variations for the bottom-up learning scheme can also be applied as variations of the reactive learning scheme. In addition, two variations can also be applied to the reactive learning scheme as follows.

In an example variation, the Depth First Search (DFS) algorithm can be used instead of BFS to traverse assets below the current asset. The children assets of the current asset are traversed by the weights in descending order.

In an example variation, weights can be used to limit the assets to be traversed. When using traversal algorithms (for example, the BFS algorithm and the DFS algorithm) to traverse assets below the current asset, only the child asset of the current asset has a weight above a predefined threshold will be considered. Since the weight represents the contribution of the corresponding child asset to the solution of the current asset, the rule here is to guarantee that the solution for only important child asset is considered to be optimized.

In a third example learning scheme, there is a deep learning scheme. In this learning scheme, the deep neural network is constructed to represent the asset hierarchy. Further, the neural network is trained to solve the business problems for the assets in the asset hierarchy.

FIG. 8 illustrates an example on how the deep learning scheme works in an asset hierarchy, in accordance with an example implementation. In this example, “Asset₁₁” is the asset at the highest level (i.e., root asset): “Asset₂₁”, “Asset₂₂” and “Asset₂₃” are assets at the next highest levels, and so on. The direct relationships among the assets are represented with the arrows. For example, “Asset₁₁” has direct relationship with “Asset₂₁”, “Asset₂₂” and “Asset₂₃”.

Below is a description of the learning algorithm in a deep learning scheme.

At first, the learning algorithm builds a deep learning neural network to represent the asset hierarchy. The input layer includes all the sensors that are installed on the assets. This is a data layer where all the sensor data are used in this layer. The output layer includes assets at the highest level in the asset hierarchy. This is the solution layer, where the solution for the asset at the highest level in the asset hierarchy is built in this layer, i.e., “Asset₁₁” in FIG. 8. The box “Asset₁₁” in FIG. 8 represents a smaller neural network where it has an input layer which get the data from a lower level in the asset hierarchy: multiple hidden layers to compute and the output layer to output the result.

Hidden layers include assets at other levels. Hidden layer 1 includes assets at the second to lowest level in the asset hierarchy: hidden layer 2 includes assets at the third to lowest level in the asset hierarchy; and so forth. Hidden layers are solution layers where the solution for each asset in the intermediate levels of asset hierarchy is built. The box for each asset in the hidden layer in FIG. 8 represents a smaller neural network where it has an input layer which gets the data from the sensors and/or assets at a lower level in the asset hierarchy: multiple hidden layers to compute and the output layer to output the result for the next level in the asset hierarchy. The connection (or link) between the unit in one layer to the unit in next layer is determined by the physical and/or logical relationship among the two units. For instance, if “Sensor₁” is only used to build solution for “Asset₂₁₁”, then there is a connection between “Sensor₁” and “Asset₂₁₁”.

Then, the learning algorithm trains the neural network for the given business problem. The whole neural network is trained and a model is built for each asset in the hidden layer and output layer to solve the business problem for each asset. The standard training process for neural network including forward propagation and backward propagation are applied. Besides, all the techniques for deep learning in neural network can be applied to the training process.

After which, the learning algorithm conducts prediction based on the neural network model and sensor data. Sensor data is collected and preprocessed. The neural network is applied to the preprocessed sensor data so as to generate results from the output layer.

Further, there are several variations for the above deep learning scheme. In one example variation, there are multiple outputs. The solution can be built for each asset in the asset hierarchy and the solution for each asset can produce output to solve the business problem(s) of the interest. In FIG. 8, each box in the hidden layers and output layer can be a solution for the business problem for the asset. An alternative solution is to build a smaller neural network up to the level that the output is expected. For instance, if output at Layer 2 is desired, then the algorithm only builds the model up to Layer 2 and use the problems at Layer 2 as the target.

In another example variation, there is multi-tasking. In a system, multiple business problems may exist and in this learning scheme, multiple solutions can be built together to solve these problems. Each of the plurality of assets can be associated with the one or more model solutions for one or more tasks. For this purpose, each asset can be associated with several solutions for different tasks. One example is that each asset is associated with multiple solutions: anomaly detection, clustering, failure detection, remaining useful life, failure prediction, and so on. The output from each solution for assets at lower level can be input to the solutions for assets at higher level. The solution of one task for the asset at lower level can help with the solution for another task for the asset at higher level. In FIG. 8, each asset in hidden layers and output layer has multiple outputs.

In another example variation, there is a deep neural network (DNN). Each layer in the neural network maps to a level in the asset hierarchy and there may be several levels in the asset hierarchy. Further, each asset has a small neural network which includes several layers as well. It is a deep network as a whole. Depending on the desired implementation, the DNN can be built to generate multiple outputs with each output for an asset from the plurality of assets in the asset hierarchy.

In another example variation, there are cross-level relationships. In standard neural networks, the connections are between the current layer and immediate next layer. However, some deep learning neural networks further involve cross layer connections which can be applied here as well. In other words, the proposed neural network in this learning scheme allows the connections between non-adjacent layers. Thus, in example implementations, the one or more model solutions are configured to capture and utilize cross-level relationships among assets, wherein the input for the one or more model solutions for an asset is from one or more of the assets or the sensors at differing lower levels. Further, the one or more model solutions can be configured to capture and utilize cross-level relationships among the plurality of assets, wherein links connect pairs of assets in non-adjacent layers in the deep neural network.

In another example variation, there can be fully connected neural networks. FIG. 8 shows a neural network structure where the connections are based on the relationships among assets in asset hierarchy. However, sometimes such relationships may not be clear or accurate beforehand. Once the sensors and the assets in each level are determined in the asset hierarchy, each sensor or asset in a level can be connected to each asset in the next level. Thus, one level or layer is fully connected to the next layer or level. Then, during the training, the weight on the connection will be determined accordingly. Large weights indicate strong connections and small weights indicate weak connections. If a weight for a connection is close to 0, that indicates the connection may not be needed. A predefined threshold can be used on the weight to determine whether the corresponding connection is needed or not. This loosens the requirements on relationships to build the solution for the assets in asset hierarchy. As a side product, the variation for fully connected neural network helps build asset hierarchy once the assets in each level is determined.

An alternative hybrid solution is to start with a fully connected neural network, then remove as many connections as possible based on domain knowledge with high confidence, then train such neural network and remove the connections with weights smaller than a predefined threshold. The asset hierarchy can thereby be refined by removing connections based on the feature importance in the one or more model solutions.

For the solution explanation 203, once the solution is built, it will be used for generating results for the business problems. However, the results may not directly be translated or mapped to some actionable outcomes. For example, the solution can generate predicted failures for the assets of the interest. The predicted failure is presented by a failure score to indicate the severity of the failure: however, it does not include any information about the causes of the failure and thus the recommended actions to remediate it. In order to remediate the predicted failure, the root cause of the predicted failure needs to be derived and remediation actions can be generated based on the root cause and the domain knowledge.

Explainable AI can be used to derive root causes for each result from the solution for an asset. Some libraries are available to perform Explainable AI. For instance, ELI5 or SHAP can be utilized to derive root causes for the result of learned model(s). Such libraries are designed to explain the result from one model or solution each time. For the assets in asset hierarchy, we can use such libraries to explain the solution and results from each solution. Beyond this, a scheme is introduced to explain the solutions and results from the solutions for the assets in the asset hierarchy by incorporating the relationships among the assets.

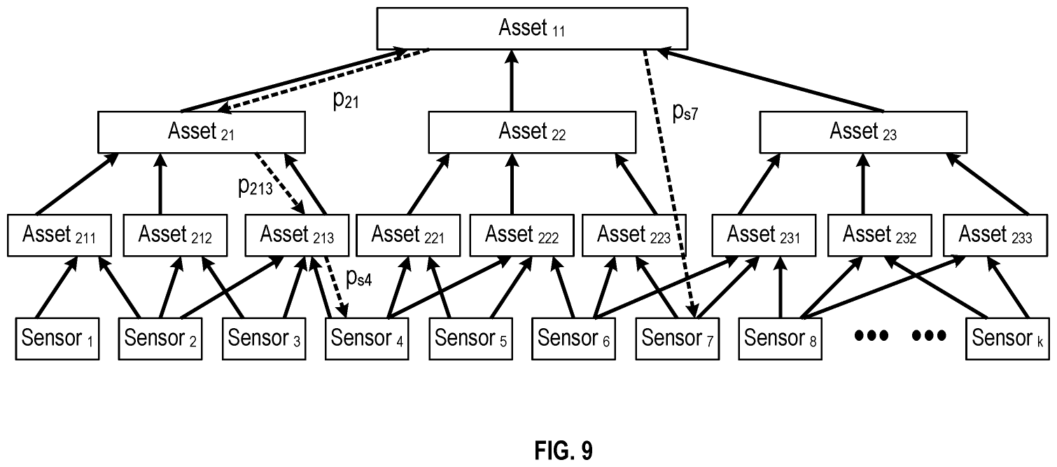

FIG. 9 illustrates an example on how the explainable AI scheme works in an asset hierarchy, in accordance with an example implementation. Specifically, FIG. 9 illustrates an example of an execution of an explaining scheme according to cross-level ones of the plurality of relationships and execution of a learning scheme by using as the target the root cause derived from failure outputs of the solutions of the each of the plurality of assets. In this example, “Asset₁₁” is the asset at the highest level (i.e., root asset): “Asset₂₁”, “Asset₂₂” and “Asset₂₃” are assets of next highest levels, and so on. The direct relationships among the assets are represented with the arrows. For example, “Asset₁₁” has direct relationship with “Asset₂₁”, “Asset₂₂” and “Asset₂₃”.

An example of the explainable AI algorithm scheme for the solution explanation 203 is provided below, as a top-down tracing scheme.

At first, the algorithm starts with the asset at the highest level in the asset hierarchy. Based on the solution for this asset, the result is derived for the data instance and the root cause for the result is derived based on root cause analysis model. For instance, ELI5 or SHAP can be utilized to derive root causes for the result.

Secondly, based on the derived root causes, the asset(s) at the lower level that lead(s) to the root causes are identified. The root cause analysis is executed for the identified assets and the root cause is derived. This step is repeated until the bottom level in the asset hierarchy is reached (i.e., the level with sensors).

For instance, in FIG. 9, based on solution for “Asset₁₁”, if the root cause for a prediction result is due to “Asset₂₁”, then path “p₂₁” is followed. Then, based on the solution for “Asset₂₁”, if the root cause for the prediction result is due to “Asset₂₁₃”, then path “p₂₁₃” is followed. Finally based on the solution for “Asset₂₁₃”, if the root cause is due to “Sensor₄”, path “ps₄” is followed.

This explaining scheme applies to both the bottom-up learning scheme and the reactive learning scheme. For the deep learning scheme, the root analysis model can be directly applied to the whole neural network so as to infer the root cause at the sensor level.

Variations for the above top-down tracing explaining scheme can include the following.

In an example variation, there is solution explaining at different levels. The solution and the results from the solution can be explained for each asset in the asset hierarchy. Example implementations can start with any asset in the asset hierarchy and apply the trace-down scheme to it. Further, the root causes can be due to assets or sensors at different levels in the asset hierarchy. For instance, in the above example, the example implementations can follow the path “p₂₁” to determine the root cause with “Asset₂₁” and the example implementations stop and conclude the root cause is with “Asset₂₁”.

In another example variation, there is also cross-level explaining. When the learning scheme involves cross-level relationship, the explaining of cross-level relationship can be enabled accordingly. For instance, in FIG. 9, based on the solution for “Asset₁₁”, if the root cause for a result is due to “Sensor₇”, example implementations follow path “ps₇” and determines the root cause is about “Sensor₇”.

In another example variation, there is also a root cause in the solution result. When a solution is built for an asset, example implementations include the root causes as the target directly. For instance, when predicting failures for an asset, besides the failure scores, example implementations also include failure modes (i.e., the group of root causes for the failures) as the target. This requires only one solution for the asset, instead of one solution to generate the results, the other solution to generate root causes.

With regards to the solution representation and storage 204, there is information representation and storage in asset hierarchy. Example implementations involve an efficient approach, knowledge graph, to represent and store the information related to the solutions in asset hierarchy. The information includes the asset hierarchy 201, the solutions from solution learning 202, the mappings between root causes to recommended actions from solution explanation 203.

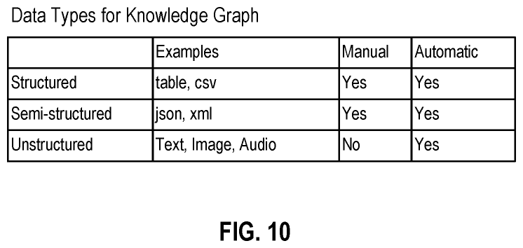

FIG. 10 illustrates an example data type for knowledge graph, in accordance with an example implementation. Depending on the types of the data that need to be represented in knowledge graph, different processes can be used (i.e., manual or automatic). Once the knowledge graph is built, the knowledge graph is stored in a graph database as known in the art. For example, the graph database can be Neo4J, ArangoDB, and so on in accordance with the desired implementation. For example, the solution learning 202 can be represented through the generation of a first knowledge graph involving a plurality of first nodes and a plurality of first edges, each of the plurality of first nodes representative of an asset from the plurality of assets and associated with the one or more model solutions for the asset from the plurality of assets, each of the plurality of first edges representative of the relationships among the plurality of assets. The solution learning 203 can be represented through generation of a second knowledge graph, the second knowledge graph involving a plurality of second nodes and a plurality of second edges, each of the plurality of second nodes comprising the knowledge for the solution explanation of the model solution for the each one of the plurality of assets, and each of the plurality of second edges representing a relationship between the knowledge for the generated solution explanation for the one or more model solutions. Such knowledge graphs are stored as the solution representation in solution representation and storage 204.

As illustrated in the data types for knowledge graph of FIG. 10, the data that needs to be represented and stored can be of different types. For example, for structured data types, the data is stored in tabular structure with columns representing variables and rows representing instances. Examples of structured data can involve the relational table format or CSV data. For the semi-structured data types, the data is represented in a form of structured data that does not obey the tabular structure, but contains tags or other markers to separate semantic elements and enforce hierarchies of records and fields within the data. For example, “XML” and “JSON” are two types of semi-structured data. For the unstructured data types, the data does not have a pre-defined data model or is not organized in a pre-defined manner. For example, text, image, video or audio data are unstructured data.

Knowledge graph can be built for all data types through manual process or automatic process, except that unstructured data can be built with automatic process only.

With regards to the components in the knowledge graph, a knowledge graph is a directed graph which can include nodes and edges. A node represents an item or entity (physically or logical), for example, staff, electrical systems, assets, etc. An edge captures the relationship of interest between the two nodes and connects them in the graph. For example, Asset₁₁ composes of Asset₂₁, or problem A is caused by root cause B.

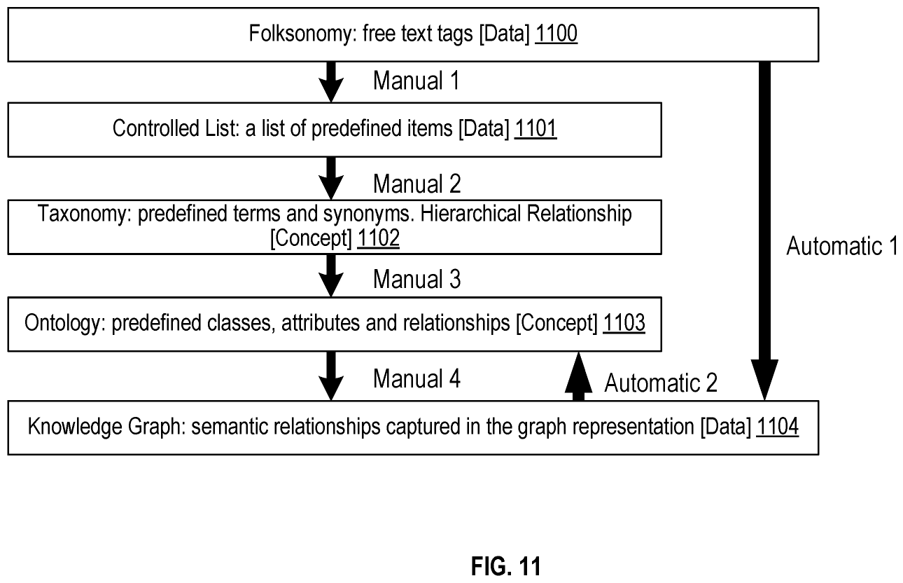

FIG. 11 illustrate an example process to build a knowledge graph, in accordance with an example implementation. Building a knowledge graph is essentially to understand the entities and their relationships among them and represent the entities as nodes and the relationships as edges. As shown in FIG. 11, there are two processes or paths to build the knowledge graph.

Manual process: example implementations can follow the steps from 1100 to 1104 as manually as indicated at “Manual 1”, “Manual 2”, “Manual 3” and “Manual 4” to build the knowledge graph. In the last step at 1004, the ontology graph is materialized with data to obtain the knowledge graph. The entities and relationships among them need to be manually identified and represented by the knowledge graph.

Automatic process: example implementations can follow “Automatic 1” to build the knowledge graph from 1100 directly to 1104, which is done through language models based on natural language processing techniques. The entities and relationships among them can be automatically identified through natural language processing techniques and represented by the knowledge graph. Optionally, “Automatic 2” from 1104 to 1103 is to abstract the knowledge graph into an ontology graph.

In the following description, example implementations list the information that are stored in the knowledge graph and are used during the solution learning and explaining process.

With regards to storing the asset hierarchy in the knowledge graph, given a system, there is first a need to identify the assets and their relationships based on domain knowledge. Then assets can be represented as nodes and relationships as edges to build knowledge graph for it through a manual process.

At first, the example implementations identify all the assets at 1100. Then, the example implementations identify the list of unique assets in the system. At 1102 and 1103, the asset types and the relationships (hierarchical and non-hierarchical) among the asset types are identified. This involves building taxonomy tree for hierarchical relationships 1102, and/or building ontology graph for non-hierarchical relationships 1103. Finally, the example implementations can materialize the ontology graph with data to build the knowledge graph at 1104. In case there are not many assets in the system, example implementations can identify the relationships among the assets directly. Thus, example implementations will directly take the process from 1100 to 1101 to 1104 to build the knowledge graph.

With regards to storing the solutions for the assets in the knowledge graph, each asset is associated with one or more model solutions for different tasks with different solution versions. In the knowledge graph that represents and stores the asset hierarchy, example implementations can add one or more entries to represent the solution. Thus, the example implementations will store the solutions with the assets together in asset hierarchy.

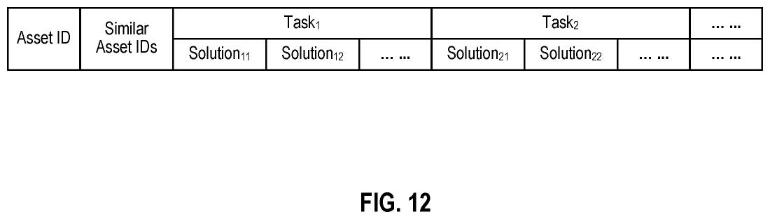

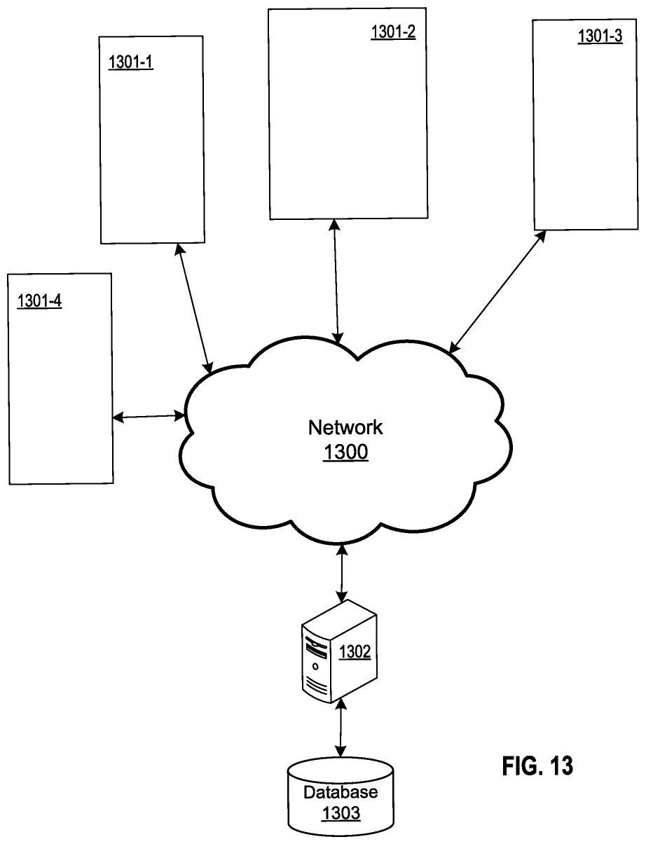

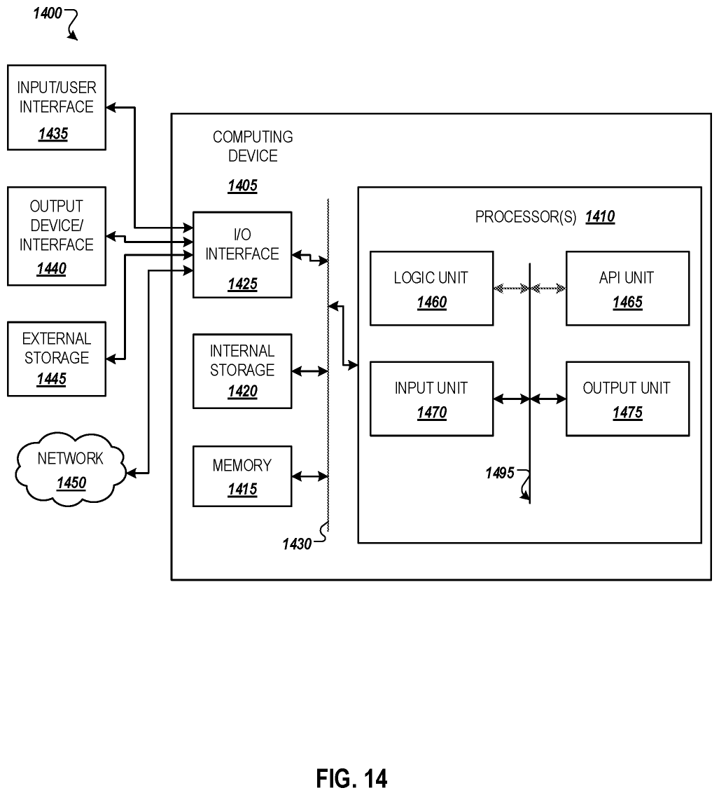

FIG. 12 illustrates an example of the information that are stored in each node of knowledge graph, in accordance with an example implementation. Each asset in the asset hierarchy can have several tasks (for example, anomaly detection, failure prediction, remaining useful life) and for each task there can be several versions of the solutions (for example, for failure prediction task, there can be a solution based on random forest classification, a solution based on sequence prediction from Recurrent Neural Network (RNN), a physics-based model based on domain knowledge and simulation), or any other machine learning model algorithms or physics-based models in accordance with the desired implementation. As a result, for each node in knowledge graph, such information is stored for this asset accordingly, as shown in FIG. 12. Accordingly, each of the plurality of assets is associated with one or more versions of the one or more model solutions for each of the one or more tasks.

With regards to using the knowledge graph for solution explanation 203, to explain the solution and the result, there is a need to map the root causes to recommended actions. Example implementations can use knowledge graph to store all the domain knowledge to explain the solution and the results.

Building the knowledge graph can be done through manual or automatic process on the structured data or unstructured data. Each entity can be represented by a node and the relationship can be represented by an edge. For instance, for a diagnosis problem, example implementations can store the following information “symptom”→“problem”→“root cause” →“remediation action”, where each “symptom”, “problem”, “root cause” and “remediation action” is represented by a node in the knowledge graph, and the relationship between each pair of entities is represented by an edge in the knowledge graph.

To query the result given some keywords, example implementations can use fuzzy query, lucence index query or sentence embedding query. Fuzzy query and lucence index query are usually provided as part of the graph database. For sentence embedding query, example implementations regard the keyword phrase as a sentence and get the sentence embedding. The query is to calculate the similarity of the sentence embedding of the keyword phase with the sentence embedding of the data in the knowledge graph and output the most similar results.

Further, the example implementations abstract the knowledge graph into the ontology graph and taxonomy tree. Tags are assigned for each entity in the knowledge graph. This can be done manually based on domain knowledge: or automatically based on some tagging algorithms. Next, the example implementations can cluster the entities based on the tags that are assigned to each entity. The entity cluster can be considered as entity type. Example implementations further add connections among entity types based on the existing connections among entities. The entity types with hierarchical relationships forms the taxonomy tree. The entity types with non-hierarchical relationships forms the ontology graph.

Further, the example implementations introduce an explanation approach for the solution and results based on the asset hierarchy. This can help explain the results at different levels (coarse to grain levels). Additionally, the example implementations introduce the use of a knowledge graph to represent and store asset hierarchy and information needed to explain the solutions. Example implementations help resolve the relationships among assets and build asset hierarchy accordingly, and the proposed solution can help refine and optimize the asset hierarchy.

FIG. 13 illustrates a system involving a plurality of systems with connected sensors and a management apparatus, in accordance with an example implementation. One or more sensor systems 1301-1, 1301-2, 1301-3, and 1301-4 are communicatively coupled to a network 1300 which is connected to a management apparatus 1302, which facilitates functionality for an Internet of Things (IoT) gateway or other management system. The management apparatus 1302 manages a database 1303, which contains historical data collected from the sensor systems 1301-1, 1301-2, 1301-3, and 1301-4, which can include labeled data and unlabeled data as received from the systems 1301-1, 1301-2, 1301-3, and 1301-4. In alternate example implementations, the data from the sensor systems 1301-1, 1301-2, 1301-3, 1301-4 can be stored to a central repository or central database such as proprietary databases that intake data such as enterprise resource planning systems, and the management apparatus 1302 can access or retrieve the data from the central repository or central database. Such systems can include robot arms with sensors, turbines with sensors, lathes with sensors, and so on in accordance with the desired implementation. The management apparatus 1302 can be in the form of the system illustrated by computing unit 302 and storage 303.

Through the example implementations described herein, several learning schemes are employed for asset hierarchy by utilizing the physical and/or logical relationships among the assets. This can help achieve better performance for the solutions of the given task(s) for each asset, provide the comprehensive health status of the whole system and prioritize the tasks accordingly. It can also help fine tune the solutions for each asset. The example implementations as described herein further address the problems of the related art outlined herein.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing.” “computing.” “calculating.” “determining.” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
generating an asset hierarchy from a plurality of assets, the asset hierarchy indicative of relationships among the plurality of assets from a lowest level to a highest level;
executing a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and
storing, in storage, the asset hierarchy, the one or more model solutions for the each one of the plurality of assets, and knowledge for a solution explanation for the one or more model solutions.

2. The method of claim 1, further comprising generating the solution explanation for each of the outputs of the model solutions for the each of the plurality of assets from the highest level to the lowest level.

3. The method of claim 2, wherein the storing, in storage, the asset hierarchy, the one or more model solutions for the each one of the plurality of assets, and the knowledge for the solution explanation for the one or more model solutions comprises:
generating a first knowledge graph, the first knowledge graph comprising a plurality of first nodes and a plurality of first edges, each of the plurality of first nodes representative of an asset from the plurality of assets and associated with the one or more model solutions for the asset from the plurality of assets, each of the plurality of first edges representative of the relationships among the plurality of assets;
generating a second knowledge graph, the second knowledge graph comprising a plurality of second nodes and a plurality of second edges, each of the plurality of second nodes comprising the knowledge for the solution explanation of the model solution for the each one of the plurality of assets, and each of the plurality of second edges representing a relationship between the knowledge for the solution explanation for the one or more model solutions; and
storing the first knowledge graph and the second knowledge graph as the solution representation.

4. The method of claim 1, wherein generating the solution explanation for the outputs of the one or more model solutions for the each of the plurality of assets from the highest level to the lowest level, comprises:
determining a root cause for each output of the one or more model solutions based on one or more of execution of a trace-down process from a higher level to a lower level of the each of the plurality of assets, execution of an explaining scheme according to cross-level ones of the plurality of relationships, and execution of a learning scheme by using as the target the root cause derived from outputs of the one or more model solutions of the each of the plurality of assets; and
incorporating the root cause as the knowledge for the solution explanation for the one or more model solutions.

5. The method of claim 1, wherein the solution learning process comprises:
learning the one or more model solutions for the each of the plurality of assets from the lowest level first;
wherein the outputs of the one or more model solutions of lower levels are utilized as inputs to learn the one or more model solutions in higher levels of the asset hierarchy in an iterative manner from the lowest level to the highest level.

6. The method of claim 1, wherein the solution learning process comprises:
calculating model performance metrics for the one or more model solutions and a weight for each of the inputs to the each of the plurality of assets;
for the model performance metrics meeting a success criteria, proceeding with the solution learning process to a next one of the each of the plurality of assets;
for the model performance metrics not meeting the success criteria:
traversing, from the each of the plurality of assets, ones of the plurality of assets that are at the lower levels in the asset hierarchy in a descending order of weights at each level;
for each of the ones of the traversed plurality of assets, executing a broader set of model algorithms and parameter sets to generate a plurality of model solutions, and applying hyperparameter optimization to the plurality of model solutions to select the model solution.

7. The method of claim 1, wherein the solution learning process comprises:
generating a deep neural network to represent the asset hierarchy, the deep neural network comprising:
an input layer representative of sensors associated with the plurality of assets;
an output layer representative of ones of the plurality of assets at the highest level in the asset hierarchy; and
one or more hidden layers representative of assets at other levels in the asset hierarchy;
wherein connections between the neural network layers represent one or more of a physical or a logical relationship in the asset hierarchy.

8. The method of claim 5, wherein the solution learning process further comprises:
using model performance metrics from the one or more model solutions at the lower levels as the input to learn the one or more model solutions at the higher levels;
wherein each of the plurality of assets is associated with the one or more model solutions for one or more tasks;
wherein each of the plurality of assets is associated with one or more versions of the one or more model solutions for each of the one or more tasks;
wherein the one or more model solutions are based on one or more of machine learning model algorithms or physics-based models;
wherein the one or more model solutions are configured to identify and utilize fault tolerance relationships among one or more of sensors or assets in the asset hierarchy, where some of the one or more of sensors or assets are configured to have a similar function or role in the system;
wherein the one or more model solutions are configured to capture and utilize cross-level relationships among assets, where the input for the one or more model solutions for an asset is from one or more of the assets or the sensors at differing lower levels; and
wherein the asset hierarchy is refined by removing connections based on the feature importance in the one or more model solutions.

9. The method of claim 6, wherein the solution learning process further comprises:
using the model performance metrics from the one or more model solutions at the lower levels as the input to learn the one or more model solutions at the higher levels;
wherein each of the plurality of assets is associated with the one or more model solutions for one or more tasks;
wherein each of the plurality of assets is associated with one or more versions of the one or more model solutions for each of the one or more tasks;
wherein the one or more model solutions are based on one or more of machine learning model algorithms or physics-based models;
wherein the one or more model solutions are configured to identify and utilize fault tolerance relationships among one or more of sensors or assets in the asset hierarchy, wherein some of the one or more of sensors or assets are configured to have a similar function or role in the system;
wherein the one or more model solutions are configured to capture and utilize cross-level relationships among assets, where the input for the one or more model solutions for an asset is from one or more of the assets or the sensors at differing lower levels; and
wherein the asset hierarchy is refined by removing connections based on the feature importance in the one or more model solutions.

10. The method of claim 6, wherein the solution learning process further comprises:
using a traversal algorithm to traverse ones of the plurality of assets below a current asset by following the descending order of the weights; and
using the weights on the connections to limit ones of the plurality of assets to be traversed.

11. The method of claim 7, wherein the solution learning process further comprises:
building the deep neural network to generate multiple outputs with each output for an asset from the plurality of assets in the asset hierarchy;
wherein each of the plurality of assets is associated with the one or more model solutions for one or more tasks; and
the one or more model solutions are configured to capture and utilize cross-level relationships among the plurality of assets, wherein the links connect pairs of assets in non-adjacent layers in the deep neural network.

12. The method of claim 1, further comprising generating the asset hierarchy through a deep learning scheme, the generating the asset hierarchy comprising:
identifying ones of the plurality of assets at each level;
generating a fully connected neural network comprising a plurality of nodes, wherein ones of the plurality of nodes at the each level are connected to other ones of the plurality of levels at a higher level over a plurality of connections;
training the fully connected neural network and obtaining weights for each of the plurality of connections; and
pruning the plurality of connections in the fully connected neural network by removing ones of the plurality of connections having weights that are lower than a predefined threshold.

13. The method of claim 1, wherein the asset hierarchy is representative of one or more of a physical hierarchy or a logical hierarchy of the plurality of assets.

14. A computer program storing instructions for executing a process, the instructions comprising:
generating an asset hierarchy from a plurality of assets, the asset hierarchy indicative of relationships among the plurality of assets from a lowest level to a highest level;
executing a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and
storing, in storage, the asset hierarchy, the one or more model solutions for the each one of the plurality of assets, and the knowledge for solution explanation for the one or more model solutions.

15. An apparatus, comprising:
a processor, configured to:
generate an asset hierarchy from a plurality of assets, the asset hierarchy indicative of relationships among the plurality of assets from a lowest level to a highest level;
execute a solution learning process to learn one or more model solutions for each of the plurality of assets based on the relationships among the plurality of assets in the asset hierarchy, wherein outputs of the one or more model solutions in lower levels of the hierarchy are utilized as inputs for the solution learning process to learn the one or more model solutions for each of the plurality of assets in higher levels of the asset hierarchy; and storing, in storage, the asset hierarchy, the one or more model solutions for the each one of the plurality of assets, and the knowledge for solution explanation for the one or more model solutions.
